(19) United States
(12) Patent Application Publication
(10) Pub. No.: US 2008/0267580 A1
(43) Pub. Date: Oct. 30, 2008

(54) Recording/reproducing apparatus

(75) Inventor: Nozomu Shimoda, Ninomiya (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/975,558

(22) Filed: Oct. 18, 2007

(30) Foreign Application Priority Data
Apr. 25, 2007 (JP) 2007-114999

(51) Int. Cl. H04N 5/93

(52) U.S. Cl. 386/52; 386/E05.001

(57) ABSTRACT

A recording/reproducing apparatus, comprising: an image pickup element; an audio input portion; a recording portion, which is configured to record video information inputted from the image pickup element and audio information inputted from the audio input portion on a recording medium, in a form of stream data; a reproducing portion, which is configured to reproduce the stream data recorded on the recording medium; a contents memory portion, which is configured to memorize a plural number of contents, each being made of video and audio, on the recording medium; a composing portion, which is configured to compose the stream data memorized in the recording medium and the contents; and a selecting portion, which is configured to select the contents to be composed with the stream data recorded on the recording medium, from among the plural number of contents, wherein the stream data recorded on the recording medium and the contents selected by the selecting portion are composed to be recorded on the recording medium.

### BACKGROUND OF THE INVENTION

A reproducing apparatus, for composing a BGM, according to user's favorite, for AV data and also reproducing thereof, is already known in the following Patent Document 1, for example.

Also, a recording/reproducing apparatus enabling recording/reproducing of AV data onto a plural number of recording media is already known in the following Patent Document 2, for example. In the Patent Document 2 is disclosed the recording/reproducing apparatus, which has a function of copying data from a first recording medium to a second recording medium.

[Patent Document 1] Japanese Patent Laying-Open No. 2004-29324 (2004); and

[Patent Document 2] Japanese Patent Laying-Open No. 2005-182864 (2005).

In recent years appears a video camera on the market, adopting a disc medium, such as, DVD, for example, representatively, as the recording medium therein, and because of no afraid of overwriting and easy reproduction and searching of AV data thereon, such DVD camera increases an acknowledgement thereof and also widen the market thereof. Also, video/audio information recorded on the DVD will not deteriorated in quality thereof, even if it is stored for a long time, and has an advantage that it can be carried easily. On the other hand, the recording capacity of DVD cannot be said to be sufficient enough to record the AV data obtained through a camera, and therefore, for example, it has a disadvantage that only the AV data of about thirty (30) minutes can be corded thereon, for one (1) pieces of DVD.

By the way, the recording capacity is also increasing in every year, in particular, of a small-size had disc, and therefore, so-called a hard disc camera also appears on the market, adopting the hard disc as the recording medium of AV data. Because the hard disc is large in the recording capacity, comparing to that of the DVD, it has an advantage that it can be record thereon AV data of a long time-period. Further, because of largeness of the recording capacity thereof, there is another advantage that it can record the AV data of high quality, being much higher than the conventional one. On the other hand, because the hard disc is expensive, it is common to build it within the camera. For that reason, differing from the DVD camera, it is not easy to carry the data recorded. Also, though the hard disc has a large capacity, but it has a limit, therefore it is impossible to record the AV data, newly, in particular, when recording is made all over the capacity thereof, if not deleting unnecessary AV data therefrom. Thus, the AV data recorded on the hard disc is inappropriate to be used for reservation.

### BRIEF SUMMARY OF THE INVENTION

Then, there can be considered a video camera installing two (2) pieces of recording media, i.e., the DVD and the hard disc thereon. With this video camera, it is possible to make the best use of the advantages of both, at the maximum, i.e., the largeness in the recording capacity of the hard disc, and the easiness of carrying and reservation of the DVD. With such the video camera mounting two (2) pieces of the recording media thereon, in this manner, it is common in the way of use, to copy the AV data onto the DVD, to reserve it, after recording the AV data on the hard disc and editing that recorded AV data on a main body of the video camera. For that reason, in particular, when editing the AV data recorded on the main body of the video camera, it is preferable or superior in usability or operability, if enabling to make an editing, such as, allowing audio contents to be given to the AV data fitting there to, for the user of BGM, for example.

However, with the conventional technologies, it is impossible to give the audio contents onto the AV data fitting thereto, in particular, when editing the AV data recorded by the video camera on the main body of the video camera, and therefore it has a problem that it is not good in the usability or operability thereof.

For dissolving such the problem mentioned above, for example, while recording audio contents for use of editing within a hard disc of large memory capacity, AV data and the audio contents for use of editing are composed, when editing the AV data, which is recorded by a video camera.

With the means mentioned above, a user can select the audio contents most fitting to the contents of the AV data recorded in the video camera, from the audio contents for use of editing recorded within the hard disc, therefore brings about preferable or superior operability or usbility.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram of a recording/reproducing apparatus, according to an embodiment of the present invention;

FIG. 2 is a flowchart for showing steps of an audio contents composing process;

FIG. 3 is a view for showing an example of monitor display, in particular, when selecting audio contents;

FIG. 4 is a view for shown an example of a monitor display, in particular, of an audio contents test listening confirmation message;

FIG. 5 is a view for showing an example of an audio contents composing process for a scene;

FIG. 6 is a view for showing an example of monitor display, in particular, of an easy audio composing menu; and

FIG. 7 is a view for showing an example of data exchanged between the recording/reproducing apparatus and other equipment.

### DETAILED DESCRIPTION OF THE INVENTION

Hereinafter, embodiments according to the present invention will be fully explained by referring to the attached drawings. The explanation will be made, by using a digital video camera (hereinafter, being simply called “video camera”) therein, which builds a hard disc and DVD (Digital Versatile Disc) therein. Further, the present invention is effective, in particular, for the scenes, where the video camera is used, in general, including school events of children, such as, an entrance ceremony, a graduation ceremony, a school sports day, a school literary exhibition, etc., events of celebrations, such as, birthday ceremony, wedding ceremony, etc., and also travel to a pleasure resort, for example. However, not restricted only to the video camera, but it is also effective to other products, such as, a desktop-type DVD recorder having no image pickup element, or the like.

Also, in the present embodiment, explanation will be made only on the case where the hard disc is built within the recording/reproducing apparatus, but not should be restricted to the built-in type, but the hard disc may be removable in the type thereof. If being the removable one, since the data recorded in the hard disc can be carried, it is easy to transfer the data into other equipment. Also, with a semiconductor memory or the like, in the place of the hard disc, it is possible to obtain the similar effect. The kind or sort of the DVD should not be limited, in particular. Also, not restricted only to the DVD, it may be other optical disc, such as, BD (Blu-ray Disc) and HD (High Definition) DVD, for example. Also, not restricted only to the combination between the HDD and the optical disc, it may be a combination between the HDD and the semiconductor memory, and the optical disc and the semiconductor memory, for example. Of course, the number of the recording media should not be restricted only to two (2), it may be three (3) or more than that. Also, the present invention can be achieved by only one (1) of the recording medium, but if composing the audio contents for the AV data recorded, but not making a copy of the data.

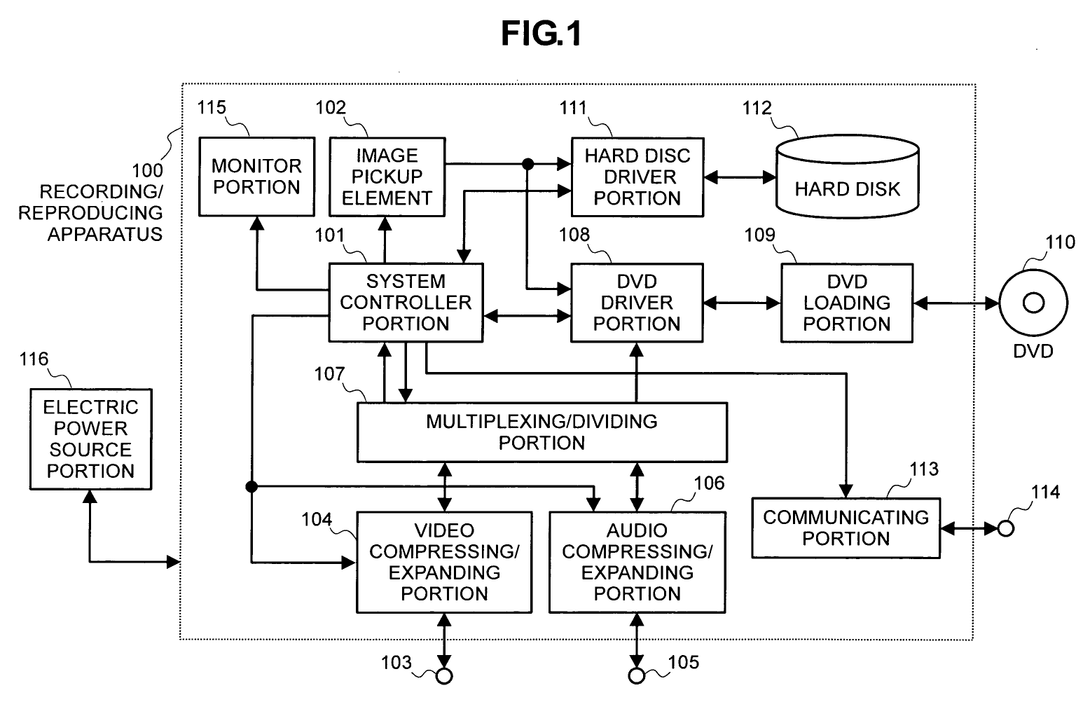

In FIG. 1, a reference numeral 100 depicts a recording/reproducing apparatus. A reference numeral 101 depicts a system controller portion, having a CPU (Central Processing Unit) and a memory, and thereby controlling the entire of a system. A reference numeral 102 depicts an image pickup element, and it picks up an image of a subject, so as to convert the image pickup information from an optic signal into an electric signal, and also from an analog electric signal into a digital signal. A reference numeral 103 depicts a video input/output terminal, for inputting and outputting of a digital video signal compressed/expanded within a video compression/expansion portion 104. A reference numeral 105 depicts an audio input/output terminal, for inputting and outputting a digital audio signal compressed/expanded within an audio compression/expansion portion 106. A reference numeral 107 depicts a multiplexing/dividing portion, and it multiplexes video compressed data and audio compressed data, being outputted from the video compression/expansion portion 104 and the audio compression/expansion portion 106, respectively, thereby producing stream data, or it divides the stream data into the video compressed data and the audio compressed data, thereby inputting the data into video compression/expansion portion 104 and the audio compression/expansion portion 106, respectively.

A reference numeral 109 depicts a DVD loading portion, into which a DVD 110 can be loaded in a freely detachable manner. A reference numeral 108 depicts a DVD driver portion, which writes the stream data and various kinds of information files, produced by the multiplexing/dividing portion 107, onto the DVD 110 in a predetermined format, through the system controller portion 101, when recording the AV data therein, or reads out the stream data and the various kinds of information files, recorded on the DVD 110, when reproducing the AV data therefrom. A reference numeral 111 depicts a hard disc driver portion, which writes the stream data and various kinds of information files, produced by the multiplexing/dividing portion 107, onto a hard disc 112 in a predetermined format, through the system controller portion 101, when recording the AV data therein, or reads out the stream data and the various kinds of information files, recorded on the hard disc 112, when reproducing the AV data therefrom. Herein, the video compression/expansion portion 104, the audio compression/expansion portion 106, the multiplexing/dividing portion 107, the DVD driver portion 108 and the hard disc driver portion 111 may be constructed to operate in a manner of hardware, i.e., in the form of circuitry, or may be memorized in the form of programs within the system controller portion 101, thereby executing the processing thereof in a manner of software. Into the DVD 110 and the hard disc 112 are mainly recorded the files, obtained by compressing the AV data on information volume thereof in a digital manner, and management information of those AV data, etc.

A reference numeral 113 depicts a communication portion, which conducts communication processing with other equipment, such as, an information processing apparatus, etc., for example, through a communication input/output terminal.

A reference numeral 115 depicts a monitor portion, which displays GUI (Graphical User Interface), such as, a menu of the recording/reproducing apparatus, for example, and in particular, it displays video information inputted through the image pickup element 102 when recoding, or video information reproduced from the DVD or the hard disc when reproducing.

An electric power source portion 116, such as, a battery or a commercial AC power source for driving the apparatus, it supplies electric power for driving the recording/reproducing apparatus.

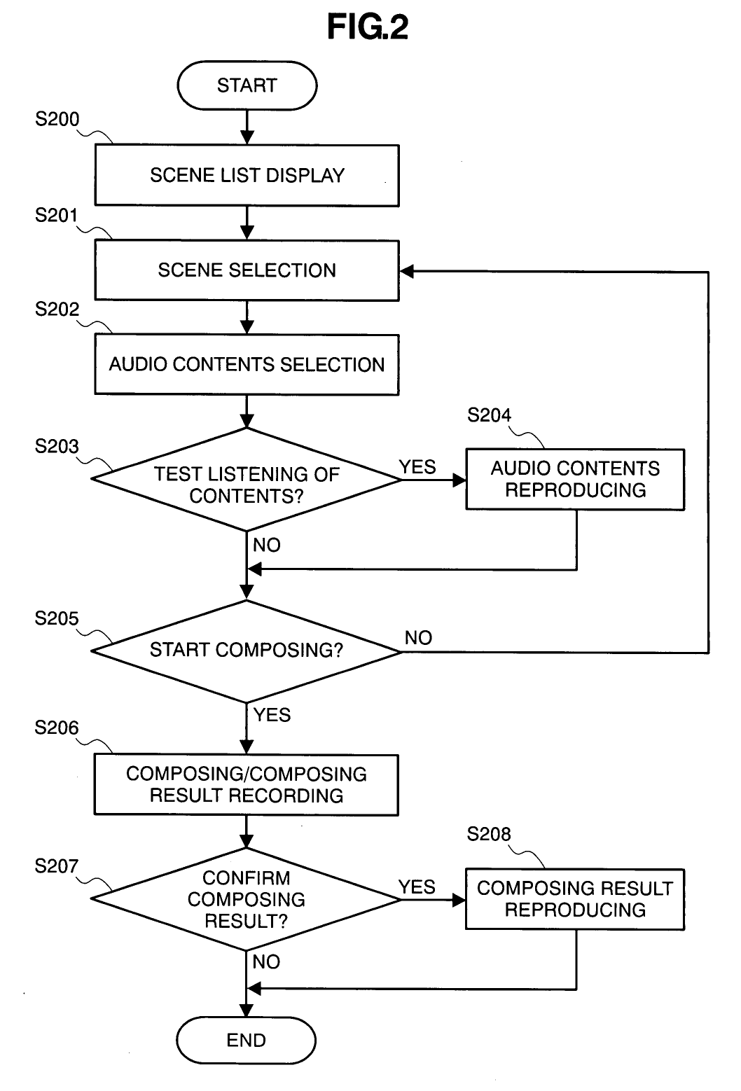

FIG. 2 is a flowchart for showing the processing of audio contents composing for the AV data. Herein, for the AV data mentioned above, it is preferable to be that, which is recorded by the video camera according to the present embodiment, but it is also possible to conduct the composing process of the audio contents thereon, if the AV data is recorded in the data format same to that of the AV data that is recorded by the video camera of the present embodiment, and if it is the AV data not protected, such as, “Edit Unable” or the like.

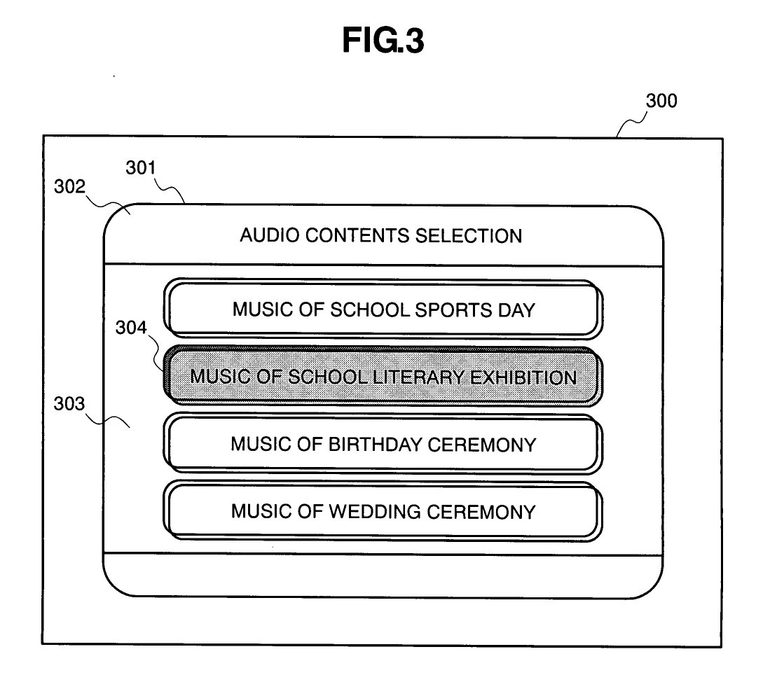

Upon receipt of an audio contents composing process start command from the user, the system controller portion starts the audio contents composing process upon the AV data. First of all, in step S200 is displayed a list of scenes on a monitor portion of the recording/reproducing apparatus, which are made of the AV data recorded in the hard disc. In this instance, what should be displayed thereon may be information for the user to identify it, such as, a thumbnail picture of each of the scenes and/or character information indicative of recording date/time, etc. In a step S201, the user is promoted to select the scene to be a target of editing, among the scenes displayed in the step S200. Next, in a step S202, the user is also promoted to select the audio contents to be composed, for the scene selected by the user. In this instance, it is sufficient to display a list of the audio contents, such as, shown in FIG. 3, for example, on the monitor of the recording/reproducing apparatus. In this FIG. 3, a reference numeral 300 depicts the monitor of the recording/reproducing apparatus. An audio contents selection screen 301 displays a list of the audio contents thereon, which are recorded into the video camera according to the present embodiment, in advance, and it is a screen, upon which selection can be made. A reference numeral 302 depicts a title display portion on the audio contents selection screen 301. A reference numeral 303 depicts an audio contents list display portion of the audio contents selection screen 301. However, in case where the number of the contents is so large that they cannot be displayed on one (1) screen, it is preferable to display that list on a scroll display. A reference numeral 304 is an audio contents select cursor, which is provided for showing the condition of selecting the audio contents that is displayed on the audio contents list portion 303. The audio contents select cursor 304 can be operated through the user interface, such as, direction keys or the like, which are provided on a remoter controller or the recording/reproducing apparatus, and the audio contents select cursor can be moved vertically, in the example shown in FIG. 3. Also, for selecting the audio contents to be composed, it is sufficient to push down a decision (or enter) key, which is provided on the remoter controller or the recording/reproducing apparatus, under the condition of putting the cursor on the desired audio contents. Further, on the audio contents select screen, there maybe displayed a list of titles of the audio contents, or the categories, such as, “school sports day”, “birthday ceremony”, etc. In case of displaying the categories, it is preferable to display the list of titles of the audio contents contained within that category, when pushing down the decision (or enter) key provided on the recording/reproducing apparatus, under the condition of putting the audio select cursor on that category.

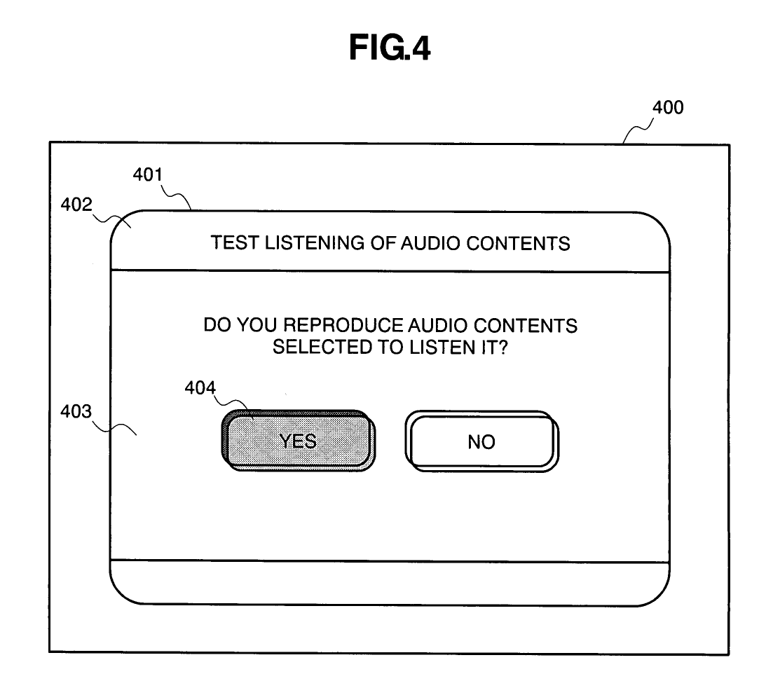

In a step S203 is displayed a message for confirming the user on if she/he wishes to listen the audio contents selected in the step S202 or not. The message displayed at that instance may be as shown in FIG. 4, for example. In this FIG. 4, a reference numeral 400 depicts a monitor of the recording/reproducing apparatus. An audio contents listening confirmation message screen 401 is a screen for the user to select on whether she/he wishes to listen the audio contents or not. A reference numeral 403 is an information display portion of the audio contents listening confirmation message screen 401. A reference numeral depicts a yes/no select cursor, with which the user can select and/or determine on whether she/he wishes to listen the audio contents or not.

Herein, when the user wishes to listen the audio contents in the step S203, the process proceeds into a step S204, so as to reproduce the audio contents selected. For the purpose of reproducing the audio contents selected, for example, data of the audio contents selected is read out from the hard disc of the recording/reproducing apparatus, and after being decoded, it is outputted from the audio input/output terminal. In case where the user does not wishes to listen the audio contents in the step S203, or in the case where reproduction of the audio contents is ended in the step S204, the process advances into a step S205. In this step S205 is displayed a message for confirming the user on whether she/he starts the process for composing the audio continents selected by the user in the step S202, for the scene that is selected by the user in the step S201. Herein, in case where the user selects starting of the composing process, the process advances into a step S206, while it turns back to the step S201 when the user selects not to start that composing process. Of course, the destination where the process turns back, when the user selecting not to start the composing process, should not be restricted only to the step S201, but it may be the step S200, for example.

In the step S206, the scene and the audio contents, which are selected by the user, are composed, and the AV data produced is recorded on a recording medium. The recording medium, recording the AV data thereon at this instance, may be the hard disc if there is remaining a sufficient empty capacity for recording that AV data produced, or may be DVD. Also, it is possible to remain the AV data thereon, which is recorded before that composing, if the empty capacity is sufficient enough, but if it is not, the AV data after that composing after deleting the AV data before that composing. Of course, it is desirable to display a message for confirming that to the user before deleting the AV data before that composing.

In a step S207 is displayed a message for confirming the user on whether she/he wishes to start reproducing process of the AV data or not, for confirming the result of that AV data produced through composing in the step S206. In case where the user selects to start the reproducing process for confirming the results of the AV data composed by the user, the process advances into a step S208, and wherein the AV data produced in the step S206 is read out and decoded, thereby to be outputted from the video input/output terminal and the audio input/output terminal. On the other hand, where the user selects not to start the reproducing process in the step S207, or when reproduction of the AV data is ended in the step S208, then the audio contents composing process for the AV data is finished. It is also possible to displayed a message for confirming the user on whether she/he finishes that composing process or not, before finishing the audio contents composing process for the AV data. This is because, there can be considered case that the user wished to conduct the composing process, again, for example, in case where the result of the AV data composed does not satisfy the user. In this instance, it can bring about superior operability or usability, if allowing the user to select one of processing steps, from which the composing process shown in FIG. 2 should be re-started.

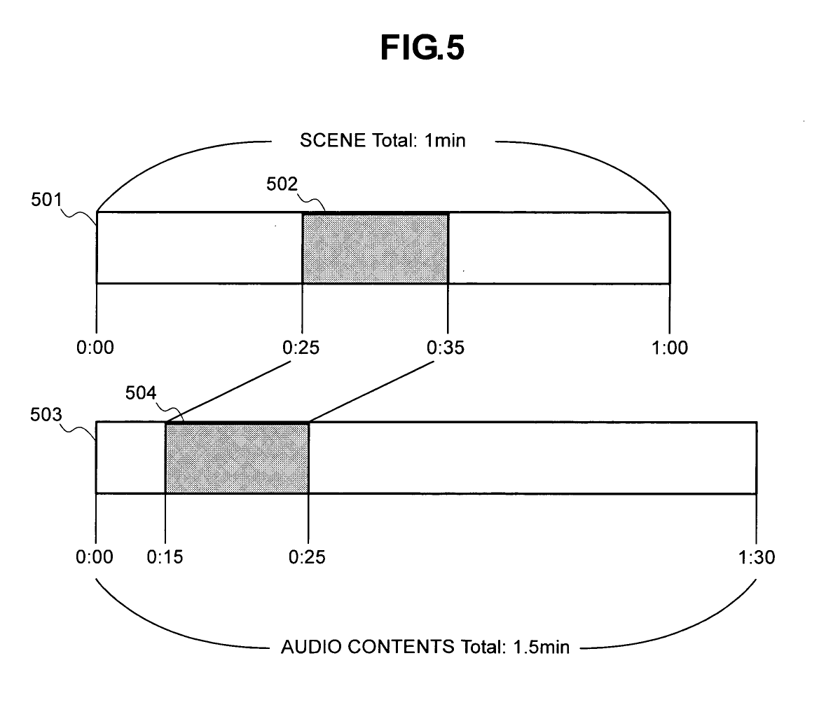

However, before starting the composing of the audio contents with the scene in the step S205, it is preferable to let the user select a portion, which should be composed, and a position of the scene, which should be the target of composing. About such a composing method will be made explanation, by referring to FIG. 5. In this FIG. 5, a reference numeral 501 depicts a scene, which is selected by the user (i.e., a user-selected scene). Assuming that the audio contents are composed for this scene, the data length of the scene is one (1) minute, in the example shown in FIG. 5. A reference numeral 502 depicts a composing target portion of the scene. Thus, this is a portion, for which the audio contents should be composed. For example, user selects one scene that is most impressive for the user, among the user-selected scenes, and for that portion should be composed the audio contents. With composing the audio contents for it, it is possible to heat up that scene, much more. A reference numeral 503 depicts user-selected audio contents. The data length of the audio contents is one (1) minute and thirty (30) seconds, in the example shown in FIG. 5, and those audio contents are composed for the user-selected scene 501. A reference numeral 504 depicts a composing target portion of the audio contents. Herein, control of the composing position is conducted, for example, with using the scene and the time information of the audio contents. FIG. 5 shows an example of setting a start position of composing the scene at the position of twenty-five (25) seconds from a top of the user-selected scene 501, while an ending position of composing the scene at the position of thirty-five (35) seconds from the top thereof. Thus, it shows the example of composing the audio contents with setting the composing target portion 502 of the scene at the ten (10) seconds designated in the above. On the other hand, for the audio contents to be composed, a star position of composing the audio contents at the position of fifteen (15) seconds from the top thereof, while setting an end position of composing the audio contents at the position of twenty-five (25) seconds from the top thereof. Thus, it is the example, while setting the composing target portion 504 of the audio contents at the ten (10) seconds set in the above, of composing the composing target portion 504 of the audio contents set herein, with the composing target portion 502 of the scene set in the above. Of course, it is possible to set the lengths of the composing target portion 502 of the scene and the composing target portion 504 of the audio contents, freely, depending on desire of the user. However, the lengths of the both data must be same to each other. Detailed setups of the audio contents for the scene, as was shown in the above, may be conducted through a user interface, which is provided by the recording/reproducing apparatus. For example, the apparatus provides a GUI for designating a portion to be composed from an image screen for showing a length of the scene and a length of the audio contents, as is shown in FIG. 5. Also, it can be considered to provide a function of setting a position to be the start position of composing while allowing the user to make an operation, such as, pushing down of a button at the position of user's desire during reproduction of the scene recorded, for example. Of course, since there is necessity of setting up, not only the start position of composing, but also the end position of composing, it is enough to let the user conduct the operation, such as, pushing down of a button, while re-staring the reproduction that was stopped once, after setting up the start position of composing, thereby setting up the end position of composing. Next, determination is made on the audio contents to be composed, for the start position of composing and the end position of composing, which are set up. In this case, also it is enough to reproduce the audio contents, in the similar manner to the scene, and set up the start position of composing and the end position of composing through the operation by the user during the reproducing thereof. Composing the scene and the audio contents in this manner enables the user to compose the scene and the audio contents while reproducing them, and therefore brings about good operability or usability for the user. Of course, the order of designation in the composing positions does not matter; even if either one of the scene or the audio contents goes ahead. Further, enabling setup of fade-in or fade-out, and/or balance adjustment of sound volumes, in particular, when composing the audio contents, enriches the editing functions, much more. Further, in this composing step, since the composing position is designated while reproducing the scene and the audio contents to be composed, separately, there is a possibility that a difference is caused in the data lengths of the both. For example, it is the case where the composing target portion of the audio contends is only nine (9) seconds though the composing target portion of the scene is ten (10) seconds. It is preferable or superior in the operability of usability thereof, to provide a function for adjusting finely, for example, effecting the fading for 0.5 seconds at a beginning and an ending of the scene composing target portion, etc., for dissolving such the difference of one (1) second, but unconsciously by the user.

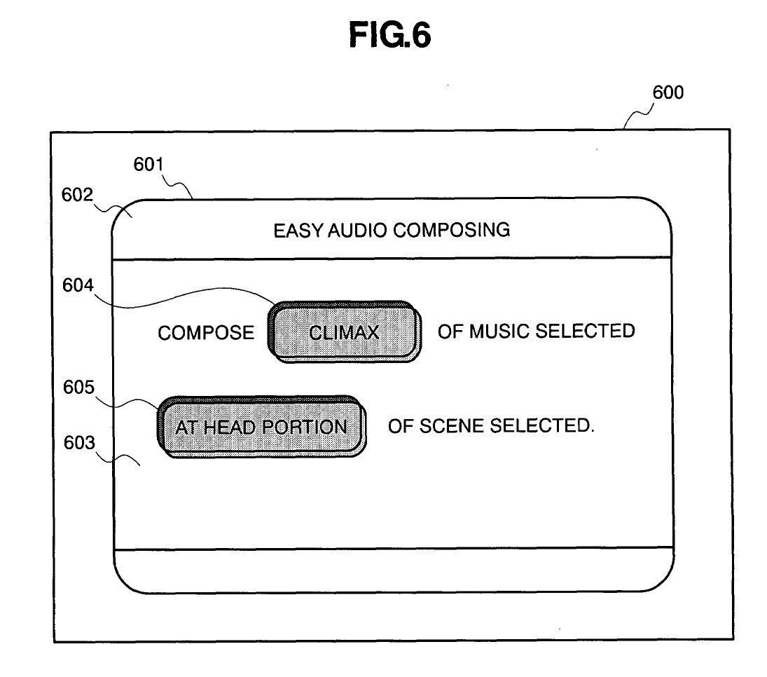

Also, with provision of a function for composing easily, by taking a user who is not good at such complicated editing operation into the consideration thereof, it is possible to bring about preferable or superior operability or usability thereof. For example, it can be considered to let the user select the scene and the audio contents to be the targets of composition, and also to let the user select, “where”, “what” should be composed. This method will be explained by referring to FIG. 6. In this FIG. 6, a reference numeral 600 depicts a monitor of the recording/reproducing apparatus. An easy audio composing menu 601 is a screen, on which the user can compose the scene and the audio contents, easily. A reference numeral 602 depicts a title display portion of the easy audio composing menu 601. A reference numeral 603 is an information display portion of the easy audio composing menu 601. A reference numeral 604 depicts a composing part select portion for the audio contents, through operations of the direction keys of which the user can select “climax (the most exiting portion)”, “A melody”, or “B melody”, etc., thereby determining the position where the audio contents should be used in the composing. A reference numeral 605 depicts a composing part select portion for the scene, through operations of the direction keys of which the user can select “top portion”, or “end portion”, etc., thereby determining the position where the audio contents should be composed on the screen. In the example shown in FIG. 6, selection is made so that the climax of the audio contents is composed at the top portion of the scene. Further, for the purpose of composing the scene and the audio components, easily, there may be considered various manners or ways, for example, a method of bringing the recording/reproducing apparatus to automatically select and determine the most suitable audio contents from the categories selected, thereby composing the both for the scene selected, while the user selects only the scene, for which the user wishes to compose the audio contents, and the category, such as, “school sports day”, “birthday ceremony”, etc. Further, for allowing the user to select one, between the ordinal audio composing process and the easy audio composing process, there can be considered a way of letting the user select through key operation from a main menu, etc., for example.

The AV data, which is produced by composing the audio contents therewith, can be moved or copied from the hard disc to the DVD; i.e., the data copied can be reserved in the form of DVD, or can be given to a friend as a present, and so on. As was mentioned above, with the video camera according to the present embodiment, the built-in hard disc can be used, only for recording of the AV data, but also for the purpose of storage of the audio contents and/or contemporary recording of the data.

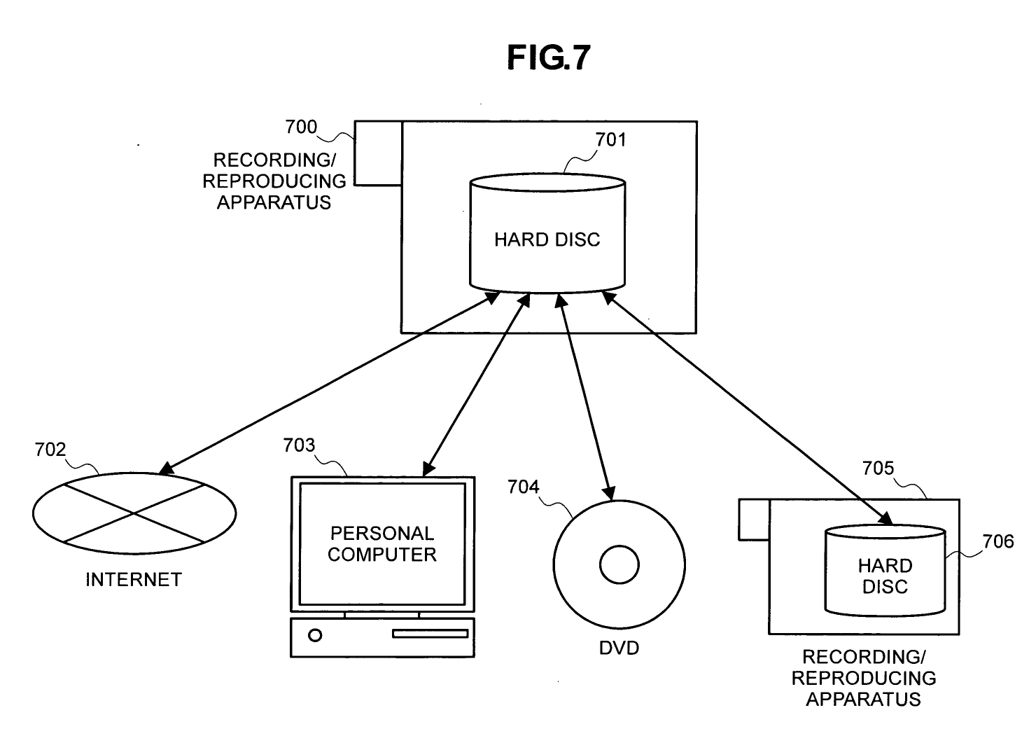

FIG. 7 shows exchange of data between the recording/reproducing apparatus and other equipment(s). A reference numeral 700 depicts the recording/reproducing apparatus. A reference numeral 701 depicts a hard disc, which is installed within the recording/reproducing apparatus 700. A reference numeral 702 depicts Internet. A reference numeral 703 depicts a personal computer. A reference numeral 704 depicts a DVD. A reference numeral 705 depicts other recording/reproducing apparatus, which has the same functions of that recording/reproducing apparatus 700. A reference numeral 706 depicts a hard disc, which is installed within the other recording/reproducing apparatus 705. The recording/reproducing apparatus 700 stores the audio contents, convenient or useful for editing the scenes, which are picked up in an event, such as, the school sports day, the school literary exhibition, the birthday ceremony and the wedding ceremony, etc., as well as, the management information thereof, into the hard disc 701. However, the data to be stored therein should not be restricted to this, but there may be stored the data and the programs for enriching the editing functions. For example, since the video camera according to the present embodiment is able to record a still picture, it can be considered to store frame video data and/or character data, etc., to be composed onto the still picture recorded. The recording/reproducing apparatus 700 comprises a mechanism for communicating between other equipment(s), i.e., various kinds of data for use of editing, which are not held within the recording/reproducing apparatus 700 can be added into the hard disc 701 thereof, by connecting with the personal computer 703 and the Internet 702. As the useful way of this function, for example, since it is possible to take the data, such as, a newest hit music or an original music composed by oneself, etc., for example, from the Internet or the personal computer, into the recording/reproducing apparatus, and therefore, i.e., editing can be made, being high in the originality or reflecting fashion of that age. However, before taking the data for use of editing therein, it is preferable to execute a process of investigating or checking on whether the data is in the format or not, being appropriate or suitable for use of editing. Also, the various kinds of data for use of editing can be taken from the DVD 704 into the recording/reproducing apparatus 700. Of course, the data can be taken therein, but from a recording medium other than the DVD. Also, it is possible to take the data for use of editing, which is stored in the hard disc 706 of the recording/reproducing apparatus 705, into the recording/reproducing apparatus 700, by connecting the recording/reproducing apparatus 700 with the other recording/reproducing apparatus. Of course, the user is able, not only to use the data made by herself/himself to be the data for use of editing, but also to customize the data for use of editing, which was stored in the recording/reproducing apparatus in advance, with an aid of the personal computer, thereby storing that customized data into the recording/reproducing apparatus, again.

However, the example mentioned above, i.e., obtaining the data for use of editing from the Internet, it can be said, brings about a business chance, from a viewpoint of seeing from a contents provider. It is possible to charge a download fee when downloading new contents, for example. In this instance, the download fee is made cheap if a user joins a group composed of only the users, who bought the video cameras, same in the type of that of the present embodiment. Further, there may be considered various ideas, such as, adding a masterpiece into a download list, while making collection of self-made contents to the users, etc.

With such the structures as was mentioned above, the user can edit the scene recorded, effectively, with using the data for use of editing, such as, the audio contents or the like, which are stored within the hard disc of the video camera, in advance, when she/he edits the scene recorded by the video camera, according to the present embodiment. In particular, it is preferable or superior in the operability or usability to make the data for use of editing, such as, the audio contents, which were stored within the hard disc of the video camera, in advance, upon supposition of the scenes to be used for the video camera, in general. Further, within the video camera, according to the present embodiment, it can be imagine that data in total of the data for use of editing, which are stored within the hard disc of the video camera, in advance, comes to be considerably large, in the size thereof. Although the hard disc increases the memory capacity thereof, every year, but it is meaningless if storing the data for use of editing into the hard disc brings about a trouble in recording of the AV data, i.e., the primarily object of the video camera. For that reason, there is necessity of contriving deal of the data for use of editing within the hard disc. For example, it is preferable to divide the storage area of data within the hard disc, i.e., 2 MB assigned as a storage area of the data for use of editing, and the remaining 18 MB assigned to a storage area for the AV data recorded, thereby not brining about interference between those data storage areas with each other. In case of obtaining new data for use of editing from the Internet, etc., for example, the data is stored in that storage area of the data for use of editing. In this instance, if there is no empty within the data storage area, then a processing is conducted, such as, deleting the data within the data storage area, etc. However, it can be said, there can be obtained less advantage for user, since storing the data for use of editing into the storage area for the AV data is contrary to the primary way of use of the video camera, although there is no technical trouble in storing the data for use of editing into the storage area of the AV data.

In the similar manner to this, there is possibility of causing a case where no empty is within the storage area of the AV data, when recording the AV data. In this instance, in general, the user is prompted delete the existing data from the storage area of the AV data. However, there can be considered a case of no necessity of the data for use of editing, depending on the user, therefore it is preferable or superior in the operability or usability thereof, to provide a mechanism for deleting the existing data from the storage area of the data for use of editing, thereby enabling to record the AV data in that area. Of course, since the data for use of editing, which is deleted once, cannot be restored, again, it is preferable to distribute the data for use of editing, again, depending on a desire of the user. For the purpose of distributing the data for use of editing, it can be considered to utilize the Internet, etc. Also, for reducing the storage area of the data for use of editing, as small as possible, the data for use of editing may be compressed.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A recording/reproducing apparatus, comprising:
an image pickup element;
an audio input portion;
a recording portion, which is configured to record video information inputted from said image pickup element and audio information inputted from said audio input portion on a recording medium, in a form of stream data;
a reproducing portion, which is configured to reproduce the stream data recorded on said recording medium;
a contents memory portion, which is configured to memorize a plural number of contents, each being made of video and audio, on said recording medium;
a composing portion, which is configured to compose the stream data memorized in said recording medium and said contents; and
a selecting portion, which is configured to select the contents to be composed with the stream data recorded on said recording medium, from among said plural number of contents, wherein
the stream data recorded on said recording medium and the contents selected by said selecting portion are composed to be recorded on said recording medium.

2. The recording/reproducing apparatus, as described in the claim 1, further comprising:
a composing controller portion, which is configured to conduct a process of determining a position of composing, with using time information of said stream data and time information of said contents, when composing the stream data and the contents by means of said composing portion.

3. The recording/reproducing apparatus, as described in the claim 2, further comprising:
a composing controller portion during reproduction, which is configured to allow a user to determine a position of composing, during when reproducing said stream data and said contents, when composing the stream data and the contents by means of said composing controller portion.

4. The recording/reproducing apparatus, as described in the claim 1, further comprising:
a temporary memorizing portion, which is configured to memorize the stream data recorded on said recording medium and contents composed stream data, which is composed with the contents selected by said selecting portion; and
a reproduction controller portion, which is configured to conduct a process of reproducing said contents composed stream data, which is memorized in said temporary memorizing portion, before recording said contents composed stream data on the recording medium by means of said recording portion.

5. The recording/reproducing apparatus, as described in the claim 1, further comprising:
a composing portion, which is configured to conduct a composing process through simple operations, without compelling complicated operations to a user, when composing said stream data and said contents.

6. The recording/reproducing apparatus, as described in the claim 2, further comprising:
a composing portion, which is configured to conduct a composing process through simple operations, without compelling complicated operations to a user, when composing said stream data and said contents.

7. The recording/reproducing apparatus, as described in the claim 3, further comprising:
a composing portion, which is configured to conduct a composing process through simple operations, without compelling complicated operations to a user, when composing said stream data and said contents.

8. The recording/reproducing apparatus, as described in the claim 1, wherein
the contents memorized in said contents memory portion includes a background music, being effective when it is composed with the stream data recorded under a situation where said recording/reproducing apparatus is used, in common.

9. The recording/reproducing apparatus, as described in the claim 1, further comprising:
a communication portion, which is configured to communicate with other equipment;
a contents obtaining portion, which is configured to conduct a process of obtaining contents through said communication portion and memorizing in the contents memory portion; and
a data format investigating portion, which is configured to conduct a process of investigating a data format of the contents obtained through said communication portion.
